(19) United States
(12) Patent Application Publication
(10) Pub. No.: US 2010/0006039 A1
(43) Pub. Date: Jan. 14, 2010

(54) Clothing article with adjustable closure

(76) Inventor: Maureen L. Edwards, Severna Park, MD (US)

Correspondence Address: LAUBSCHER & LAUBSCHER, P.C., 1160 SPA ROAD, SUITE 2B, ANNAPOLIS, MD, 21403, US

(21) Appl. No.: 12/317,944

(22) Filed: Dec. 31, 2008

Related U.S. Application Data
(60) Provisional application No. 61/134,544, filed on Jul. 11, 2008.

(51) Int. Cl. A01K 13/00

(52) U.S. Cl. 119/850

(57) ABSTRACT

A pet bandana is characterized by an adjustable snap closure so that the bandana can be fit to the size of the pet on which the bandana is to be worn. The bandana is formed from a layer of fabric having a pair of studs connected in spaced relation adjacent to one corner of the fabric and a cap connected with an opposite corner. By arranging the bandana about the neck of the pet and selecting which stud the cap is connected with, the bandana is secured to the animal with an optimum fit. The snap closure improves the safety of the bandana since it can easily be released should the bandana become caught in a door, fence, or the like with the pet being able to release the closure by pulling away from the bandana.

This application claims the benefit of U.S. provisional application No. 61/134,544 filed on Jul. 11, 2008.

### BACKGROUND OF THE INVENTION

Bandanas have commonly been used as decorative apparel. In addition to being worn by humans, bandanas have been used as decorative apparel for pets, particularly dogs. Animal garments such as bandanas provide a decorative look when placed around the animal's neck. However, the decorative options have been limited to low quality, thin cotton, novelty design fabrics which are either tied around a dog's neck or secured with a VELCRO type fastener or plastic clips.

Conventional dog bandanas have certain drawbacks. Because of the difficulty in tying thicker fabrics, most bandanas are limited to thin cotton fabrics. Those that incorporate VELCRO type fasteners or plastic clips tend to either be difficult to fasten or release or tend to become entangled with the dog's fur which reduces the fastener's capability over time. In addition, certain prior fasteners may not readily release in the event that the bandana becomes entangled in a fence, door or the like, thereby risking the health of the animal. The present invention was developed in order to overcome these and other drawbacks of prior dog bandanas by providing a garment that incorporates an adjustable snap closure.

### SUMMARY OF THE INVENTION

Accordingly, it is a primary object of the invention to provide a garment formed from a first layer of fabric having a geometric shape and an adjustable snap closure connected with the fabric. More particularly, the closure includes at least two studs arranged in spaced relation adjacent to a first corner of the fabric and a cap arranged adjacent to a second corner of the fabric. The cap is removably connected with one of the studs to adjust the size of the garment in accordance with the size of the body portion on which the garment is worn. Preferably, the fabric has a triangular shape and the garment comprises a bandana to be worn by a pet such as a dog. For larger furry dogs, the snap cap is connected with the stud closest to the corner of the fabric to maximize the size of the bandana when worn about the dog's neck. For smaller dogs or those with less fur, the snap is connected with another stud along an edge of the fabric.

According to a preferred embodiment, a trim layer of fabric is connected with the first layer of fabric at least along an edge thereof where the studs and cap are connected with the first layer of fabric. This increased the thickness of the bandana in the snap area which enhances of the ability of the snaps to be connected with the fabric without becoming disengaged therefrom. The studs and cap are connected with the fabric layers by any conventional device such as a snap pliers or an industrial snap machine.

The fabric may comprise any pliable material such as velvet, wool, corduroy, suede, vinyl and terry cloth.

### BRIEF DESCRIPTION OF THE FIGURES

Other objects and advantages of the invention will become apparent from a study of the following specification when viewed in the light of the accompanying drawing, in which:

FIG. 1 is a front plan view of the garment of the invention in an unsnapped condition;

FIG. 2 is a rear plan view of the garment of FIG. 1 in the snapped condition;

FIGS. 3 and 4 are top plan views of a stud and cap, respectively, of the snap connection according to the invention; and

FIG. 5 is a plan view of the garment according to the invention won about the neck of a dog.

### DETAILED DESCRIPTION

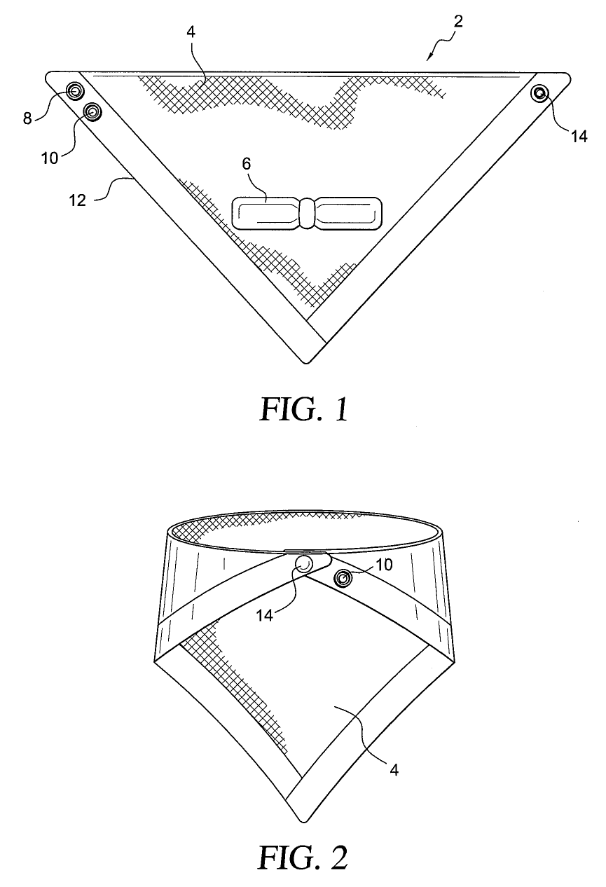

Referring to FIGS. 1 and 2, the adjustable garment according to the invention will be described. The garment 2 includes a layer of fabric 4 having a geometric shape. In the embodiment shown in the drawing, the garment is a bandana and the fabric has a triangular configuration. It will be appreciated that other geometric shapes may be provided depending on the desired final configuration of the garment.

The fabric can be any suitable material such as velvet, wool, corduroy, suede, vinyl, and terry cloth. If desired a decorative design 6 may be printed on or stitched to the fabric or woven therein. Moreover, a different decorative pattern may be printed on the opposite side of the fabric.

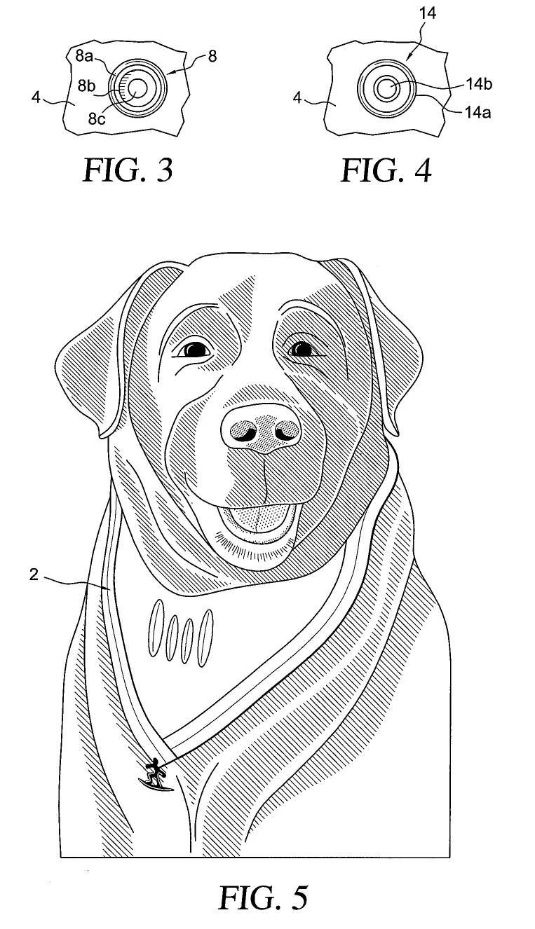

The decorative bandana according to the invention is designed to be worn around the neck of a pet such as a dog. In order to retain the bandana on the dog, an adjustable snap closure is connected with the bandana. More particularly, the snap closure includes a pair of spaced studs 8, 10 connected with the fabric adjacent to a corner thereof and preferably along an edge 12. A cap 14 is connected with an opposite corner of the fabric. In FIG. 3, the construction of the stud 8 is shown. It includes a lower annular portion 8a which abuts against the fabric and a raised cylindrical portion 8b having a lip at its upper edge to be received in the cap 14. A prong 8c in the central area of the stud annular portion serves to secure the stud to the fabric, usually using a crimping tool such as snap pliers or an industrial snapping machine. The stud 10 has an identical construction as the stud 8. The interior of the cap 14 is shown in FIG. 4 and includes a rim portion 14a which snaps over the lip of the stud in a conventional manner. The cap also includes a prong or socket 14b in a central portion thereof which is secured to the fabric by a crimping tool in the same manner as the stud.

As set forth above, the studs are arranged in spaced relation as shown in FIG. 1. The user can select which stud on which the cap is snapped in order to connect the bandana on the dog. The outermost stud 8 closest to the corner of the bandana provides a larger opening in the folded and secured bandana as shown in FIG. 2. For a smaller opening, such as for arranging the bandana on a smaller dog or one with less fur, the cap is snapped onto the second stud 10. Additional studs may be provided spaced along the edge 12 to provide progressively smaller openings in the folded bandana for mounting the bandana on smaller animals.

Referring now to FIG. 5, the bandana is worn around the neck of the dog. It can be worn below the dog's face as shown in FIG. 5, wherein the snap area will be behind the dog's neck. Alternatively, the bandana can be worn at the back of the neck with the snap area below the dog's face, or at the side of the neck with the snap area on the opposite side. The adjustable snap connection prevents the bandana from wrapping around the pet's neck, thereby avoiding repositioning of the bandana and maximizing the comfort for the pet. A further option is to reverse the bandana to display the decorative pattern provided on the opposite side of the fabric.

Referring once again to FIG. 1, trim layers of fabric 16 may be provided along the edges of the bandana. These can be stitched onto the first layer 4, or a portion of the first layer can be folded back and stitched to itself to provide a two-layer portion. Suitable trim layers include lace, jacquard, and grosgrain. The trim layers provide an improved visual appearance to the bandana as well as a thicker region for mounting the snap closure studs and cap.

Unlike VELCRO® type fasteners, the snap fastener used in the invention is not susceptible to having the pet's fur interfere with the closure. Thus, a safe, reliable, and comfortable closure is provided. In addition, the snap closure improves the safety of the bandana by quickly releasing should the bandana become caught and the pet tries to pull away.

The fabric can also be provided in different sizes. With the invention, a pet owner can select the proper size bandana in accordance with the size of the dog or pet on which the bandana is worn, and then by selecting the appropriate stud and snap cover connection, fit the bandana to the pet to retain the bandana in the desired position while displaying the decorative pattern.

While the preferred forms and embodiments of the invention have been illustrated and described, it will be apparent to those of ordinary skill in the art that various changes and modifications may be made without deviating from the inventive concepts set forth above.

What is claimed is:

1. A garment, comprising
(a) a first layer of fabric having a geometric shape;
(b) an adjustable snap closure connected with said fabric including at least two studs arranged in spaced relation adjacent to a first corner of said fabric and a cap arranged adjacent to a second corner of said fabric, said cap being removably connected with one of said studs to adjust the size of the garment in accordance with the size of a body portion upon which the garment is worn.

2. A garment as defined in claim 1, wherein said geometric shape comprises a triangle.

3. A garment as defined in claim 2, wherein said studs are arranged adjacent to an edge of said fabric.

4. A garment as defined in claim 3, and further comprising a second layer of fabric connected with said first layer of fabric at least along the edges thereof to provide a trim layer for the garment and increased thickness in the areas of the garment where said studs and said cap are connected therewith.

5. A garment as defined in claim 4, wherein said garment comprises a bandana adapted to be worn by an animal.

6. A garment as defined in claim 4, wherein said fabric comprises at least one of velvet, wool, corduroy, suede, vinyl, and terry cloth.

7. A garment as defined in claim 4, and further comprising a decorative design connected with at least one side of said fabric.
